(19) United States
(12) Patent Application Publication
(10) Pub. No.: US 2017/0337486 A1
(43) Pub. Date: Nov. 23, 2017

(54) FEATURE-SET AUGMENTATION USING KNOWLEDGE ENGINE

(71) Applicant: Futurewei Technologies, Inc., Plano, TX (US)

(72) Inventors: Hui Zang, Cupertino, CA (US); Zonghuan Wu, Cupertino, CA (US)

(21) Appl. No.: 15/157,138

(22) Filed: May 17, 2016

(51) Int. Cl. G06N 99/00; G06N 5/02; G06F 17/30

(52) U.S. Cl. CPC G06N 99/005; G06F 17/30477; G06N 5/02

(57) ABSTRACT

A method includes receiving an original feature-set for training a machine learning system, the feature-set including multiple records each having a set of original features with original feature values and a result, querying a knowledge base based on the set of original features, receiving a set of knowledge features with knowledge feature values responsive to the querying of the knowledge base, generating a first augmented feature-set that includes the multiple records of the original feature set and the knowledge features for the multiple records, and training the machine learning system based on the first augmented feature-set.

### FIELD OF THE INVENTION

The present disclosure is related to augmentation of a feature-set for machine learning and in particular to feature-set augmentation using a knowledge engine.

### BACKGROUND

In machine learning, a model, such as a linear or polynomial function is fit to a set of training data. The training data may consist of records with values for a feature set selected from known data and include a desired output or result for each record in the training data. A feature is a measurable property of something being observed. Choosing a comprehensive set of features can help optimize machine learning. The set of features may be used to train a machine learning system by associating a result with each record in the set of features. The machine learning system will configure itself with programming that learns to derive the associated result correctly, and then be applied to data that is not in the feature set to provide results.

For example, if a machine learning system is being trained to recognize US coins, the features may include a name of a building on one side of the coin, such as Monticello, and name of a head shot on the other side, such as Thomas Jefferson, which corresponds to a US nickel. An initial set of features may not be sufficient, such as in the case of US quarters, where each state may have a different image on one side of the coin, or may be too redundant or large to be optimal for machine learning related to a particular domain.

The selection of features to facilitate machine learning has previously been done utilizing knowledge of a domain expert.

### SUMMARY

A method includes receiving an original feature-set for training a machine learning system, the feature-set including multiple records each having a set of original features with original feature values and a result, querying a knowledge base based on the set of original features, receiving a set of knowledge features with knowledge feature values responsive to the querying of the networked knowledge base, generating a first augmented feature-set that includes the multiple records of the original feature set and the knowledge features for the multiple records, and training the machine learning system based on the first augmented feature-set.

A non-transitory machine readable storage device has instructions for execution by a processor of the machine to perform operations. The operations include receiving an original feature-set for training a machine learning system, the feature-set including multiple records each having a set of original features with original feature values and a result, querying a knowledge base based on the set of original features, receiving a set of knowledge features with knowledge feature values responsive to the querying of the knowledge base, generating a first augmented feature-set that includes the multiple records of the original feature set and the knowledge features for the multiple records, and training the machine learning system based on the first augmented feature-set.

A device comprises a processor and a memory device coupled to the processor and having a program stored thereon for execution by the processor to perform operations. The operations include receiving an original feature-set for training a machine learning system, the feature-set including multiple records each having a set of original features with original feature values and a result, querying a knowledge base based on the set of original features, receiving a set of knowledge features with knowledge feature values responsive to the querying of the knowledge base, generating a first augmented feature-set that includes the multiple records of the original feature set and the knowledge features for the multiple records, and training the machine learning system based on the first augmented feature-set.

### BRIEF DESCRIPTION OF THE DRAWINGS

FIG. 1 is a data structure representing records in a data set and a corresponding original set of features according to an example embodiment.

FIG. 2 is a block diagram illustrating a process of obtaining additional features to generate an augmented feature set according to an example embodiment.

FIG. 3 is a representation of a data structure corresponding to a join of data structures that includes the original features and knowledge of new features according to an example embodiment.

FIG. 4 is a chart illustrating different feature levels according to an example embodiment.

FIG. 5 is a data structure representation of a feature set that includes original features, some of the knowledge features, plus high level features, which together comprise a further augmented feature set according to an example embodiment.

FIG. 6 is a chart illustrating creation of hierarchical features from a set of features according to an example embodiment.

FIG. 7 is a block flow diagram illustrating a computer implemented method of augmenting an original feature set for a machine learning system according to example embodiments.

FIG. 8 is a block diagram of a system for use in discovering additional features according to example embodiments.

FIG. 9 is a representation of an interface for selecting features to add to the original feature-set according to example embodiments.

FIG. 10 is a block schematic diagram of a computer system to implement one or more methods and engines according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, a multi-core processing system, or other type of processor operating on a computer system, such as a personal computer, server or other computer system, turning such computer system into a specifically programmed machine.

An original feature set derived from a dataset for training a machine learning engine is enhanced by searching an external network for additional features. The additional features may be added to the original feature set to form an augmented feature set. Hierarchical clustering of the additional features may be performed to generate higher level features, which may be added to form a further augmented feature set.

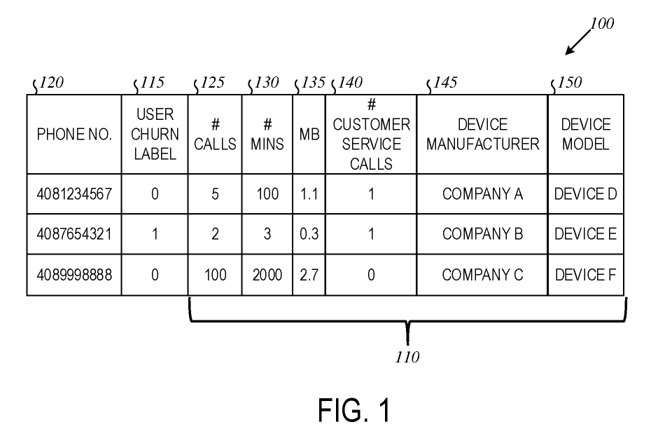

FIG. 1 is a data structure 100 representing records in a data set and a corresponding original set of features 110 with values related to predicting or categorizing whether a user of a cellular phone is likely to switch cellular network carriers. Those users that tend to switch carriers more often are categorized with a value of “1” in a user churn label column 115. Users that do not switch carriers often are given a value of “0”. The users may be identified by a phone number in a column 120. There are three users shown in the data set 100, having features that include of number of calls 125, number of minutes 130, megabytes (MB) used 135, number of customer service calls 140, device manufacturer 145 and device model 150. While only three users are shown in data structure 100, in further embodiments, many more records may be included such that data structure 100 may be used to train a knowledge engine to properly categorize a user that has not been previously categorized.

The original feature set may be obtained from an internal database with the use of a domain expert. Some features in the original feature set may not be well correlated to the proper categorization, which can lead to overfitting. Overfitting occurs when a statistical model or function is excessively complex, and may describe random noise instead of an underlying relationship to a desired result. In other cases, there may be too few features that were available in a data set used to generate the features, leading to inaccurate results of the trained machine learning system, such as a neural network, for example.

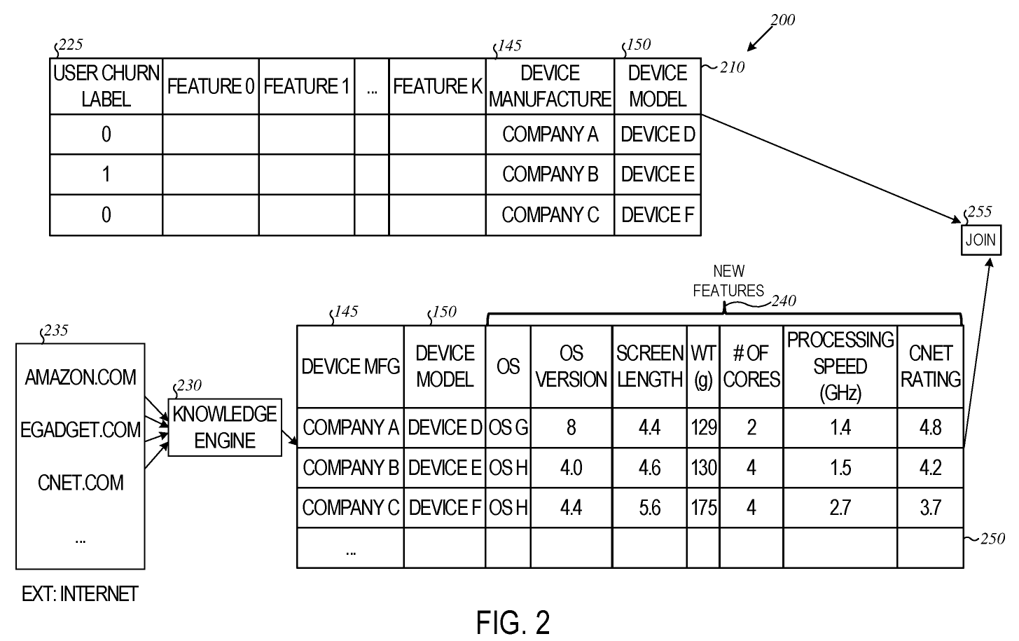

FIG. 2 is a block diagram illustrating a process 200 of obtaining additional features to generate an augmented feature set. A data set 210 has three records with a corresponding original feature set that includes features 0 through k, which may correspond to the features in FIG. 1, plus a device manufacturer feature 145 and device model feature 150. A result 225 for each record in the data set in this embodiment is also a churn indication, such as a churn label of “0” or “1”. In one embodiment, the values of the device manufacturer feature 145 and device model feature 150 may be used by a knowledge engine 230 to query external information sources 235 such as the internet using various internet based services, such as Amazon.com, Egadget.com, CNET.com, and others which may provide further information about the values in the features, such as Company A Device D, Company B Device E, and Company C Device F corresponding to the feature values for the records. The Knowledge engine will use the result obtained to identify new features 240, which in some embodiments, include an operating system (OS), OS version, screen length, weight, number of cores, processing speed, and CNET rating. The search results may also be used to fill in values for each of the new features for each record, to create a data structure 250 that includes the new features 240 with values (as well as the features 145 and 150 that the queries used to generate the new features were based on). The features 145 and 150 thus exist in both data structures 210 and 250, allowing a join of the data structures 210 and 250 to be performed, as indicated at 255.

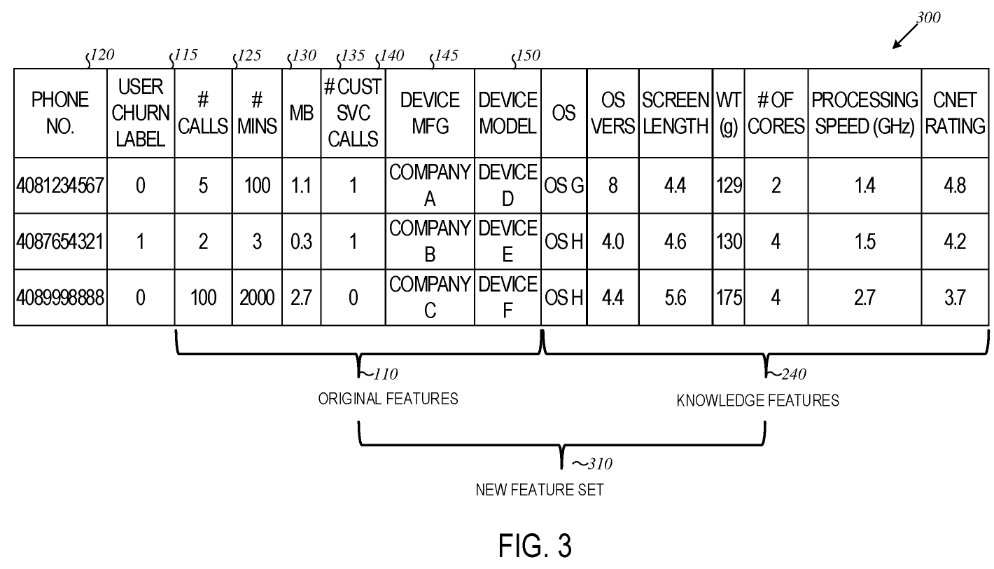

FIG. 3 is a representation of a data structure 300 corresponding to a join of data structures 100 and 250 that includes the original features, and knowledge of new features 240 to comprise a new features set 310. Note that the user churn label column 115 remains the same. Data structure 300 in one embodiment corresponds to an augmented feature set that may be used to better train the machine learning system.

Some features sets may contain too many features, leading to overfitting. In machine learning, when there are too many features in the set of training data, the model that results from the training may describe random errors or noise, leading to inconsistent results when the model is applied to data outside the training set. A model that has been overfit will generally have a poorer predictive performance, as it can exaggerate minor fluctuations in the training data.

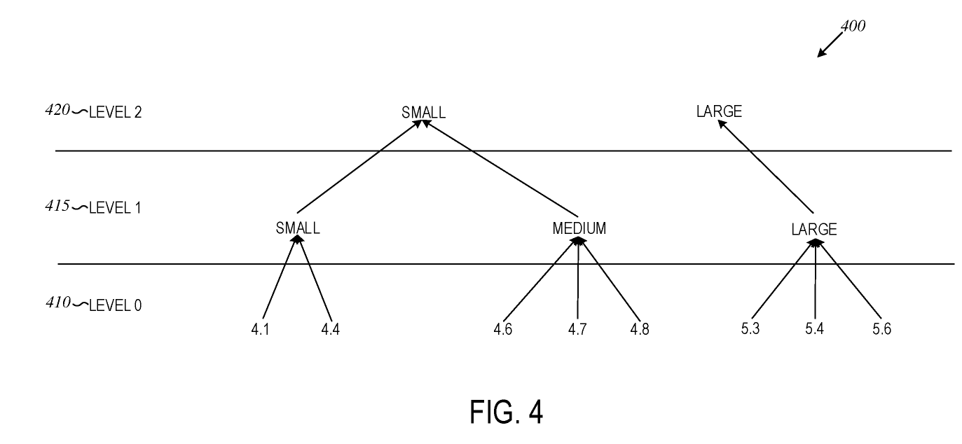

FIG. 4 is a chart 400 illustrating a way of creating higher level features, at 400 for one feature, such as screen length. Values for the screen lengths are shown at a level 0 at 410. At a higher level, level 1 at 415, some of the values are combined into clusters having a small, medium, and large rating. The cluster having a small rating at level 1 includes screen length values between 4.1 and 4.4. The medium rating at level 1 includes screen length values between 4.6 and 4.8, and the large rating at level 1 includes screen length values between 5.3 and 5.6.

At a level 2 420, the small and medium values of level 1 are combined into level 2 small values cluster, while the large values of level 1 remain large values cluster in level 2. Thus, eight values in level 0 have been converted into one of two cluster values, small and large, simplifying the feature set.

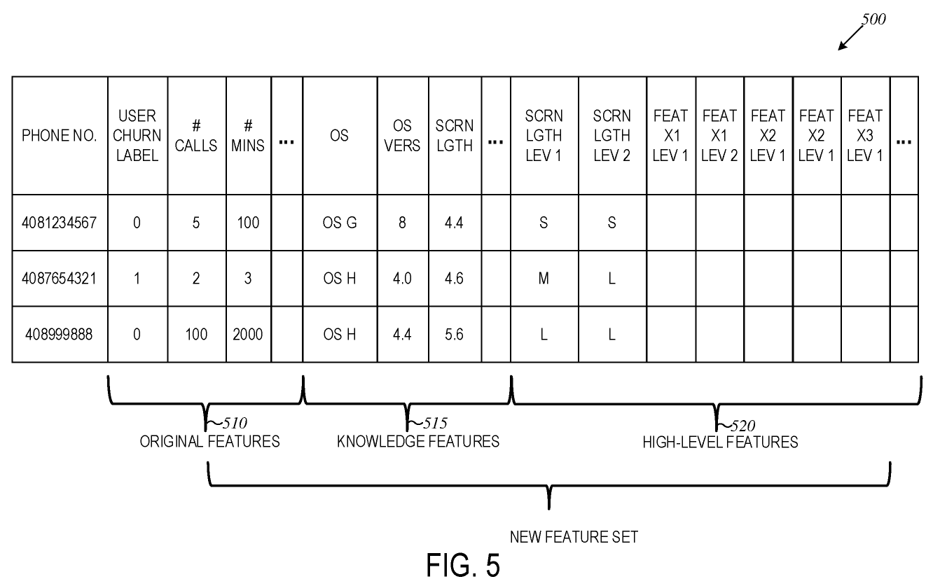

FIG. 5 is a data structure representation of a feature set 500 that includes original features 510, some of the knowledge features 515, plus high level features indicated at 520, which together comprise a further augmented feature set 500. A first high level feature includes the screen length 525 having values of S, M, and L, corresponding to small, medium, and large as in level 1 415. A second high level features includes the screen length 530 having values of S and L, corresponding to level 2 420. Feature set 500 may include several other features, X1, X2, and X3 having different levels 1 and 2.

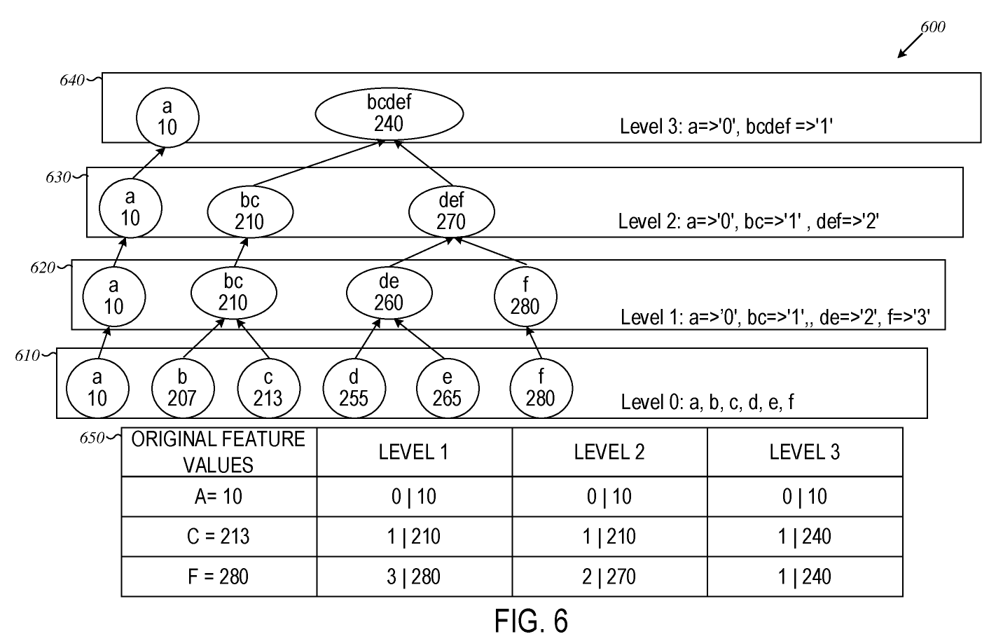

FIG. 6 is a chart 600 illustrating a way of creating hierarchical levels for a feature, using a machine learning method referred to as hierarchical clustering. At a level 0 at 610, the original feature values are represented by letters a, b, c, d, e, and f. These letters can represent different types of values. For example, they can be numeric, text/strings, vectors, or nominal values. In each embodiment, a through f should represent the same type of values. In one embodiment, at level 0, 610, each feature value in level 0 may be a real (numeric) value, a=10, b=207, c=213, d=255, e=265, and f=280. Some of the values are shown as combined in a second level 1 at 620, forming multiple clusters of feature values, where feature value a remains a single feature value with real value 10, feature values b and c are combined in a cluster and given a real value of 210, feature values d and e are combined in a cluster with a real value of 260, and feature value f remains alone with a real value of 280. Note that the six feature values of level 0 have been reduced to four clusters of feature values in level 1, with each cluster assigned a cluster feature value. This new feature value can again be numeric. In another embodiment, this new feature value can be nominal, as represented by ‘0’, ‘1’, ‘2’, and ‘3’. In a higher level 2 at 630, feature value a remains a single feature value with real value 10, feature values b and c remain a combined feature value with real value 210, and feature values d, e, and f are combined with a real value of 270. In yet a higher level 3 at 640, feature value a remains a single feature with real value 10, and feature values b, c, d, e, and f have been combined and have a real value of 240. Note that in level 3 at 640, the original six feature values a through f have been further reduced to two clusters of feature values with two different real values 10 and 240. In each step, the value of the cluster is calculated as the mean of the immediate lower level values in that cluster. In another embodiment, the value of the cluster is calculated as the mean of the original values in that cluster. In another embodiment, the value of the cluster is calculated as the median of the immediate lower level values in that cluster. In another embodiment, the value of the cluster is calculated as the median of the original values in that cluster. In another embodiment, the value of the cluster is nominal and the nominal values as shown as ‘0’, ‘1’, ‘2’, ‘3’, is only meaningful for the current level.

A table 650 show three original feature values a, c, and f, and how their values changed or did not change at each of the hierarchical levels. Original feature value, a, maintained the same real value of 10 at each of the four levels. Original feature value, c, also had a real value that changed in each of the higher levels. The original real value of f, changed from 280, to 270 in level 2 and 240 in level 3.

The various levels in FIG. 6 may be referred to as a family of hierarchical features of one feature. The hierarchical features provide different granularities of representation of the same physical feature. For the final model, one level in the family may be selected as being best for that feature.

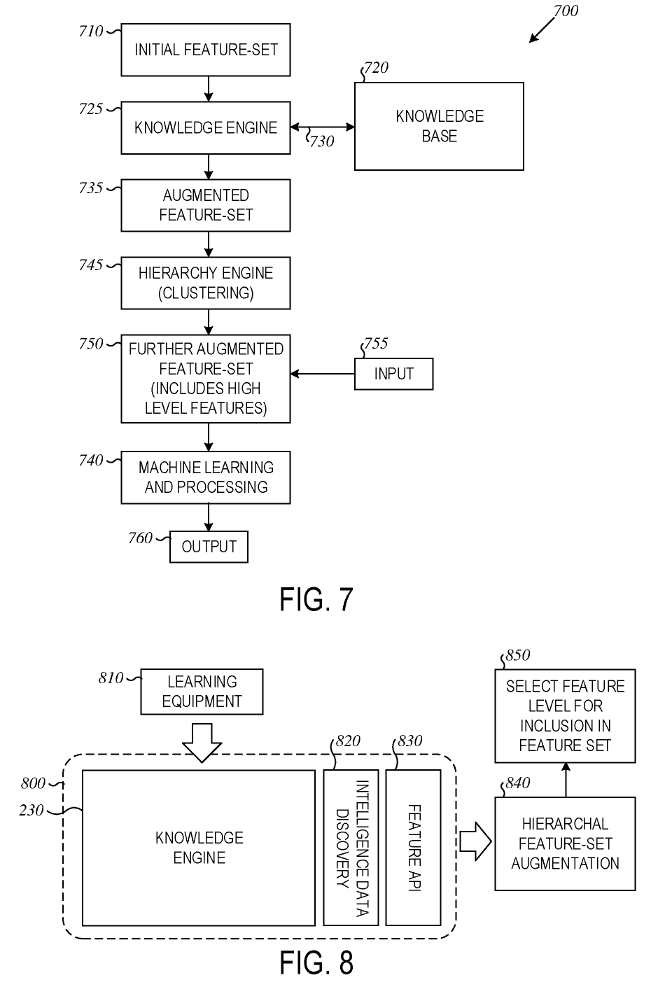

FIG. 7 is a block flow diagram illustrating a computer implemented method 700 of augmenting an original feature set for a machine learning system. Method 700 includes receiving at 710 an original feature-set for training the machine learning system. The original feature-set 710 includes multiple records each having a set of original features with original feature values and a result. A networked knowledge base 720 is queried based on the set of original features 710. A knowledge engine 725 may be used to generate and perform the query or queries, as well as generate new features based on information obtained by the query. In one embodiment, the knowledge base 720 may comprise a networked knowledge base, such as the Internet, and the original features may comprise cellular phone information and the result comprises a carrier churn value.

At 730, a set of knowledge features is received from the knowledge engine, with knowledge feature values responsive to the querying of the networked knowledge base. A first augmented feature-set 735 is generated that includes records of the original feature set 710 and the knowledge features 730 for the multiple records. In one embodiment, the machine learning system 740 is trained based on the first augmented feature-set 735.

Hierarchical clustering, or other clustering techniques, may be used to expand the number of representations of a feature or group of features. In one embodiment, a hierarchy engine 745 may be used to create different levels of a feature. One or more of such levels may be added to the augmented feature set 735 to produce a further augmented feature set 750, which may also be used to train the machine learning system 740. The high level feature values of the further augmented feature set 750 may comprise numeric or nominal values. In another embodiment, a set of features are first grouped or mathematically combined, then clustering is applied to this group of features or the combined feature to create higher level features.

With hierarchical clustering, a series of levels may be generated, with each level having an entire set of observations residing in a number of clusters. Each level represents a different granularity. In other words, the higher levels have fewer clusters that contain the entire set of observations. In order to decide which clusters should be formed and/or combined if forming cluster from a bottom up approach, a measure of dissimilarity or distance between observations may be used. In one example, clusters may first be formed by pairing observations that are closest to each other, followed in a further level by combining clusters that are closest to each other. There are many different ways that clusters may be formed. In addition to the bottom up approach, which is referred to as agglomerative clustering, a top down, or divisive approach may also be used such that all observations start in one cluster and are split recursively moving down the hierarchy of levels. When clustered, the value of a given feature may be a median or mean of the values that are clustered at each hierarchical level.

The formation of clusters is also affected by the method used to determine the distance of observations from each other. Various distance functions that may be used in different embodiments include a median distance function, a Euclidean distance function, a Manhattan distance function, a Cosine distance function, or a Hamming distance function.

In one embodiment, there may be a known number of values (say S/M/L, or XS/S/M/L/XL, or S/L), K-means may be used for clustering where K is the known number of different values (3 for S/M/L, or 5 for XS/S/M/L/XL). Other clustering techniques may be used in further embodiments. Note that in this scenario, only one higher-level feature is generated.

In one embodiment, multiple feature values may be mathematically combined to produce a further feature. One example may include multiplying the width and length feature values to produce an area feature. In one embodiment related to determining user churn of wireless carrier network services, the multiple knowledge features comprises a length and width of various cell phones, wherein the length and width are multiplied to produce an area of the cell phone as the further knowledge feature.

Once the machine learning system 740 is trained with one or more of the feature sets, the machine learning system 740 may be used to predict results on records that are not yet in the feature sets, designated as input 755, used to train system 740. System 740 processes the input in accordance with algorithms generated based on the training feature set, and provides a result as an output 760. The output may indicate whether or not a potential new customer is likely to change carriers often. Such an output may be used to offer incentives or different cell phone plans to the potential new customer based on business objectives.

FIG. 8 is a block diagram of a system 800 for use in discovering additional features. A learning requirement 810 is used as input to the knowledge engine 230, which generates a query based on values in one or more features in a data set as represented at intelligent data discovery function 820. The intelligent data discovery function 820 may be automated by searching all values of all features and correlating results consisting of new features with each of the records in the data set.

In one embodiment, the system 800 may output an importance or significance value of each feature. The features may be sorted based on the value and top features, or those features having values exceeding a threshold may be selected for inclusion in some embodiments. In further embodiment, a feature pruning step may be applied based on one or more methods commonly used in feature selection, such as testing subsets of features to find those that minimize error rates, or wrapper methods, filter methods, embedded methods, or others.

An original feature and its expanded higher level representations may be referred to as a feature family. Via feature pruning, one best level per feature family (similar to choosing the best granularity for a feature) may be selected to be included in the final model. By performing feature selection following generation of higher level features via augmentation as described above, potentially useful higher level features are not excluded prior to being generated.

A feature application programming interface (API) 830 may be used interact with the set of new features to select features to augment. The selected features may be provided to a hierarchical feature-set augmentation function 840, which may operate to create one or more hierarchical levels as previously described. The level in each family to include in a further augmented feature set may be selected via the knowledge engine 230 via feature pruning, or may be specifically selected by a user at 850 by selecting a feature level, resulting in a further augmented hierarchical feature set.

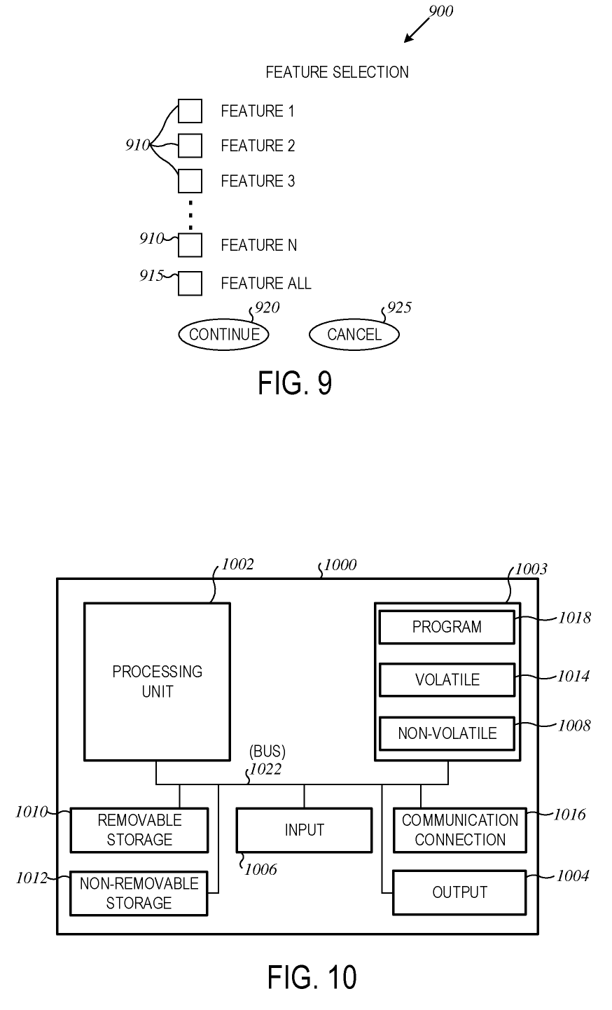

An interface for selecting and editing new features and hierarchical features to add to the original feature-set is illustrated at 900 in FIG. 9. In one embodiment, the features may be described in a list with a checkbox 910 next to each feature. A feature may be included by the user simply checking the checkbox. An option may be provided to select all the features listed as indicated by checkbox 915. A continue selection 920 may be used to add the selected features to the feature set, and a cancel selection 925 may be used to cancel out of the feature selection interface 900.

The feature listing may be alphabetical based on a feature name, and screen size limits show only features that begin with the letter “A” up to a partial listing of features that begin with the letter “C”. Some of the features may have names of active_user, age, alert_balance, alertdelay, answer_count, etc.

FIG. 10 is a block schematic diagram of a computer system 1000 to implement one or more methods and engines according to example embodiments. All components need not be used in various embodiments. One example computing device in the form of a computer 1000, may include a processing unit 1002, memory 1003, removable storage 1010, and non-removable storage 1012. The components of the computer 1000 may be interconnected via a bus 1022 or other communication element. Although the example computing device is illustrated and described as computer 1000, the computing device may be in different forms in different embodiments. Although the various data storage elements are illustrated as part of the computer 1000, the storage may also or alternatively include cloud-based storage accessible via a network, such as the Internet. Computer 1000 may also be a cloud based resource, such as a virtual machine.

Memory 1003 may include volatile memory 1014 and non-volatile memory 1008. Computer 1000 may include—or have access to a computing environment that includes—a variety of computer-readable media, such as volatile memory 1014 and non-volatile memory 1008, removable storage 1010 and non-removable storage 1012. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

Computer 1000 may include or have access to a computing environment that includes input 1006, output 1004, and a communication connection 1016. Output 1004 may include a display device, such as a touchscreen, that also may serve as an input device. The input 1006 may include one or more of a touchscreen, touchpad, mouse, keyboard, camera, one or more device-specific buttons, one or more sensors integrated within or coupled via wired or wireless data connections to the computer 1000, and other input devices. The computer 1000 may operate in a networked environment using the communication connection 1016 to connect to one or more remote computers, such as database servers, including cloud based servers and storage. The remote computer may include a personal computer (PC), server, router, network PC, a peer device or other common network node, or the like. The communication connection 1016 may include a Local Area Network (LAN), a Wide Area Network (WAN), cellular, WiFi, Bluetooth, or other networks.

Computer-readable instructions stored on a computer-readable storage device are executable by the processing unit 1002 of the computer 1000. A hard drive, CD-ROM, and RAM are some examples of articles including a non-transitory computer-readable medium such as a storage device. The terms computer-readable medium and storage device do not include carrier waves or signals. For example, a computer program 1018 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 1000 to provide generic access controls in a COM based computer network system having multiple users and servers.

### Examples

1. In example 1, a method includes receiving an original feature-set for training a machine learning system, the feature-set including multiple records each having a set of original features with original feature values and a result, querying a knowledge base based on the set of original features, receiving a set of knowledge features with knowledge feature values responsive to the querying of the networked knowledge base, generating a first augmented feature-set that includes the multiple records of the original feature set and the knowledge features for the multiple records, and training the machine learning system based on the first augmented feature-set.

2. The method of example 1 and further comprising combining multiple values of a single feature to create at least one higher level feature having at least two clusters of higher level feature values.

3. The method of example 2 and further comprising selecting at least one higher level feature from a number of higher level features for a physical feature for inclusion in the first augmented feature set for training the machine learning system.

4. The method of any of examples 2-3 wherein a feature value of each cluster is a function of a mean or median value of the feature values in the cluster.

5. The method of any of examples 1-4 and further comprising creating high level feature values from mathematically combined knowledge features, or a group of knowledge features

6. The method of any of examples 4-5 wherein the mathematically combined features comprises a length and width, and wherein the length and width are multiplied to produce an area as the further feature value.

7. The method of any of examples 4-5 wherein the high level feature values comprise numeric or nominal values.

8. The method of any of examples 1-7 wherein the knowledge base comprises a networked knowledge base.

9. The method of any of examples 1-8 wherein multiple feature values are combined into clusters of higher level feature values based on one or more of a Euclidean distance function, a Manhattan distance function, a Cosine distance function, or a Hamming distance function.

10. The method of any of examples 1-9 wherein the networked knowledge base comprises the Internet, and wherein the original features comprise cellular phone information and the result comprises a carrier churn value.

11. The method of any of examples 1-10 and further comprising providing an interface to select features to include in the augmented feature set.

12. In example 12, a non-transitory machine readable storage device has instructions for execution by one or more processors to perform operations. The operations include receiving an original feature-set for training a machine learning system, the feature-set including multiple records each having a set of original features with original feature values and a result, querying a knowledge base based on the set of original features, receiving a set of knowledge features with knowledge feature values responsive to the querying of the knowledge base, generating a first augmented feature-set that includes the multiple records of the original feature set and the knowledge features for the multiple records, and training the machine learning system based on the first augmented feature-set.

13. The non-transitory machine readable storage device of example 12 wherein the operations further comprise combining multiple values of a single feature to create at least one higher level feature having at least one cluster of higher level feature values.

14. The non-transitory machine readable storage device of any of examples 12-13 wherein multiple feature values are combined into clusters of higher level feature values based on one or more of a Euclidean distance function, a Manhattan distance function, a Cosine distance function, or a Hamming distance function to produce a further knowledge feature.

15. The non-transitory machine readable storage device of any of examples 12-14 wherein the networked knowledge base comprises the Internet, and wherein the original features comprise cellular phone information and the result comprises a carrier churn value.

16. In example 16, a device includes a processor and a memory device coupled to the processor and having a program stored thereon for execution by the processor to perform operations. The operations include receiving an original feature-set for training a machine learning system, the feature-set including multiple records each having a set of original features with original feature values and a result, querying a knowledge base based on the set of original features, receiving a set of knowledge features with knowledge feature values responsive to the querying of the knowledge base, generating a first augmented feature-set that includes the multiple records of the original feature set and the knowledge features for the multiple records, and training the machine learning system based on the first augmented feature-set.

17. The device of example 16 wherein the operations further comprise combining multiple values of a single feature to create at least one higher level feature having at least one cluster of higher level feature values.

18. The device of example 17 wherein the multiple feature values are combined into clusters of higher level feature values based on one or more of a Euclidean distance function, a Manhattan distance function, a Cosine distance function, or a Hamming distance function to produce a further knowledge feature.

19. The device of any of examples 16-18 wherein the operations further comprise creating high level feature values from mathematically combined knowledge features, wherein the mathematically combined features comprises a length and width, and wherein the length and width are multiplied to produce an area as the further feature value.

20. The device of any of any of examples 16-19 wherein the knowledge base comprises the Internet, and wherein the original features comprise cellular phone information and the result comprises a carrier churn value.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A method comprising:
receiving an original feature-set for training a machine learning system, the feature-set including multiple records each having a set of original features with original feature values and a result;
querying a knowledge base based on the set of original features;
receiving a set of knowledge features with knowledge feature values responsive to the querying of the knowledge base;
generating a first augmented feature-set that includes the multiple records of the original feature set and the knowledge features for the multiple records; and
training the machine learning system based on the first augmented feature-set.

2. The method of claim 1 and further comprising combining multiple values of a single feature to create at least one higher level feature having at least two clusters of higher level feature values.

3. The method of claim 2 and further comprising selecting at least one higher level feature from a number of higher level features for a physical feature for inclusion in the first augmented feature set for training the machine learning system.

4. The method of claim 2 wherein a feature value of each cluster is a function of a mean or median value of the feature values in the cluster.

5. The method of claim 1 and further comprising creating high level feature values from mathematically combined knowledge features, or a group of knowledge features.

6. The method of claim 4 wherein the mathematically combined features comprises a length and width, and wherein the length and width are multiplied to produce an area as the further feature value.

7. The method of claim 4 wherein the high level feature values comprise numeric or nominal values.

8. The method of claim 1 wherein the knowledge base comprises a networked knowledge base.

9. The method of claim 1 wherein multiple feature values are combined into clusters of higher level feature values based on one or more of a Euclidean distance function, a Manhattan distance function, a Cosine distance function, or a Hamming distance function.

10. The method of claim 1 wherein the knowledge base comprises the Internet, and wherein the original features comprise cellular phone information and the result comprises a carrier churn value.

11. The method of claim 1 and further comprising providing an interface to select features to include in the augmented feature set.

12. A non-transitory machine readable storage device having instructions for execution by one or more processors to perform operations comprising:
receiving an original feature-set for training a machine learning system, the feature-set including multiple records each having a set of original features with original feature values and a result;
querying a knowledge base based on the set of original features;
receiving a set of knowledge features with knowledge feature values responsive to the querying of the knowledge base;
generating a first augmented feature-set that includes the multiple records of the original feature set and the knowledge features for the multiple records; and
training the machine learning system based on the first augmented feature-set.

13. The non-transitory machine readable storage device of claim 12 wherein the operations further comprise combining multiple values of a single feature to create at least one higher level feature having at least one cluster of higher level feature values.

14. The non-transitory machine readable storage device of claim 12 wherein multiple feature values are combined into clusters of higher level feature values based on one or more of a Euclidean distance function, a Manhattan distance function, a Cosine distance function, or a Hamming distance function to produce a further knowledge feature.

15. The non-transitory machine readable storage device of claim 12 wherein the knowledge base comprises the Internet, and wherein the original features comprise cellular phone information and the result comprises a carrier churn value.

16. A device comprising:
a processor; and
a memory device coupled to the processor and having a program stored thereon for execution by the processor to perform operations comprising:
receiving an original feature-set for training a machine learning system, the feature-set including multiple records each having a set of original features with original feature values and a result;
querying a knowledge base based on the set of original features;
receiving a set of knowledge features with knowledge feature values responsive to the querying of the knowledge base;
generating a first augmented feature-set that includes the multiple records of the original feature set and the knowledge features for the multiple records; and
training the machine learning system based on the first augmented feature-set.

17. The device of claim 16 wherein the operations further comprise combining multiple values of a single feature to create at least one higher level feature having at least one cluster of higher level feature values.

18. The device of claim 17 wherein the multiple feature values are combined into clusters of higher level feature values based on one or more of a Euclidean distance function, a Manhattan distance function, a Cosine distance function, or a Hamming distance function to produce a further knowledge feature.

19. The device of claim 16 wherein the operations further comprise creating high level feature values from mathematically combined knowledge features, wherein the mathematically combined features comprises a length and width, and wherein the length and width are multiplied to produce an area as the further feature value.

20. The device of claim 16 wherein the knowledge base comprises the Internet, and wherein the original features comprise cellular phone information and the result comprises a carrier churn value.
